(19) United States
(12) Patent Application Publication
(10) Pub. No.: US 2012/0031548 A1
(43) Pub. Date: Feb. 9, 2012

(54) Apparatus and Method for Applying a Label to a Non-ruled Surface

(76) Inventor: Gavin J. Broad, Liberty Township, OH (US)

(21) Appl. No.: 12/851,569

(22) Filed: Aug. 6, 2010

(51) Int. Cl. B32B 37/02; B65C 9/10; B65C 9/12; B65C 9/02

(52) U.S. Cl. 156/230; 156/539

(57) ABSTRACT

Apparatus for applying a label to a non-ruled surface. The apparatus comprises a label supply element, an array of label conformation pallets, a pressure source, and an array of target-object presentation stations. The label supply element comprises a peel tip disposed adjacent to a carrier film path and a label path diverging from the carrier film path at the peel tip. The array of label conformation pallets is constrained to circumnavigate a pallet path. Each pallet comprises a shell defining a cavity associated with a predefined shape of a non-ruled surface of a target object and having a perimeter, and a flexible membrane occluding the cavity along the perimeter. The target-object presentation stations are adapted to hold individual target objects and constrained to circumnavigate a target-object path, a portion of the target-object path disposed adjacent to the pallet path.

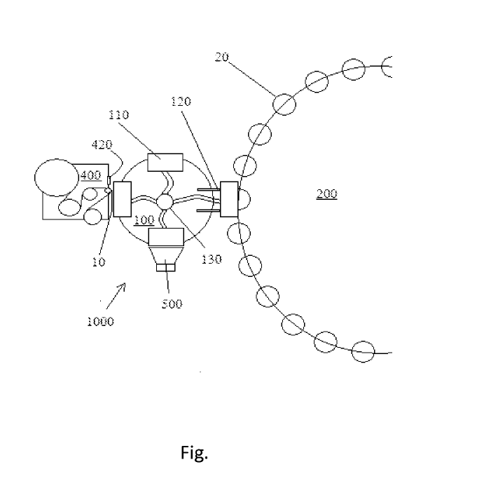

### FIELD OF THE INVENTION

The invention relates to the field of applying labels to target surfaces. The invention relates particularly to apparatus and methods for applying an adhesive backed label to a non-ruled surface.

### BACKGROUND OF THE INVENTION

Manufacturers of packaged products face increasing difficulties in differentiating their products on store shelves and in making a desired impression upon their intended consumers. One method of accomplishing these goals is using unique package shapes and unique package decorations. Pressure sensitive labels are a well known means of decorating objects including packages. One limit of pressure sensitive and other types of labels is their ability to conform to package surfaces as those surfaces become more complex and also the ability to automatically apply the labels to more complex package surfaces. As manufacturers desire to utilize increasingly unique packages having complex surface shapes requiring decoration, what is desired are apparatus and methods for the application of pressure sensitive adhesive backed labels to non-ruled target surfaces of objects.

### SUMMARY OF THE INVENTION

In one aspect, an apparatus for applying a label to a non-ruled target surface comprises a label supply element, an array of label conformation pallets, a pressure source, and an array of target-object presentation stations. The label supply element comprises a peel tip disposed adjacent to a carrier film path and a label path diverging from the carrier film path at the peel tip. The array of label conformation pallets is constrained to circumnavigate a pallet path; at least a portion of the pallet path is disposed adjacent to the label path. Each pallet comprises a shell defining a cavity associated with a predefined shape of a non-ruled surface of a target object and having a perimeter, and a flexible membrane occluding the cavity along the perimeter. The pressure source is connected to the cavity of each pallet of the array. The target-object presentation stations are adapted to hold individual target objects and constrained to circumnavigate a target-object path, a portion of the target-object path disposed adjacent to the pallet path. Each target object comprises a non-ruled surface having a pre-defined shape.

In one aspect a method of applying a label to a non-ruled surface, the method comprising steps of: providing a label comprising a first side and a second side, the second side at least partially coated with an adhesive, the label disposed upon a label path; providing a label pallet comprising a cavity defining a perimeter and having a shaped inner wall comprising a non-ruled surface, and a membrane disposed adjacent to the cavity perimeter, the pallet circumnavigating a pallet path, a portion of the pallet path disposed adjacent to a portion of the label path; transferring the label from a carrier film to the label pallet membrane; applying a negative pressure to the cavity of the label pallet; conforming a portion of the pallet membrane and label to a portion of the non-ruled surface of the cavity wall; providing a target object comprising a non-ruled surface associated with the non-ruled surface of the shaped inner cavity wall; translating the pallet membrane label combination to a location proximate to the non-ruled surface of the target object; and transferring the label from the pallet membrane to the non-ruled surface of the target object.

### BRIEF DESCRIPTION OF THE DRAWINGS

FIGURE is a schematic plan view of one embodiment of the apparatus of the invention.

### DETAILED DESCRIPTION OF THE INVENTION

As used herein, a label comprises a discrete portion of a flexible, substantially planar web material having a first side and a second side. One side of the label may be coated with a pressure sensitive adhesive. The label may be printed or otherwise decorated. Labels may be provided as discrete items or may be provided disposed upon a carrier film. The carrier film may comprise silicone or other surface energy reducing agents to facilitate the removal of the labels as desired.

As used herein, a ruled surface is defined as a surface through every point of which there is a line that lies in the surface. A developable surface is defined as a surface which may be flattened into a plane without distortion or which may be developed out of a plane without distorting the plane. A non-ruled surface is one for which these definitions are not true, that is, a surface which is neither ruled nor developable.

In one embodiment, an apparatus for applying a label to a non-ruled target surface comprises a label supply element, an array of label conformation pallets, a pressure source, and an array of target-object presentation stations.

The label supply element comprises a peel tip disposed adjacent to a carrier film path and a label path diverging from the carrier film path at the peel tip. The label supply element provides a means of unwinding a roll of labels disposed upon a carrier film. The roll of carrier film is unwound, the film proceeds along a carrier film path. The film carrying the labels is constrained to proceed past a peel tip. The procession of the film/label combination past the peel tip results in the separation of the label from the carrier film. The separated label moves along a label path that deviates from the carrier film path. The carrier film, or liner, stripped of the labels proceeds to the wind up reel and is wound into a new roll without labels.

The label supply element may be sized to receive rolls of labels according to the dimensions of the labels. The label supply element may incorporate automatic splicing means to enable a more seamless transition in the overall operation of the labeling apparatus by eliminating any need to stop operations to change the supply roll of labels. In one embodiment, a label dispenser, Label-aire Model #3114, available from Label-aire, of Fullerton, Calif., USA, was used to provide labels to the label pallets of the apparatus.

The label supply element may be synchronized to the motion of the label conformation pallets such that a label is disposed in front of the label conformation pallet and may be acquired by the label conformation pallet. The synchronization may be accomplished via a pallet detection sensor coupled to the label supply element controller. The label supply element may feed a label as the sensor output indicates the presence of a label conformation pallet. Alternatively, a controller may track the position of the label conformation pallets via a resolver or encoder coupled to the drive system of the pallet turret. The controller may signal the label supply element as appropriate to trigger the provision of a label to an arriving pallet.

The array of label conformation pallets is constrained to circumnavigate a pallet path; at least a portion of the pallet path is disposed adjacent to the label path. The pallets may be so constrained by being unitized into a pallet turret. Such a turret may comprise the entire array and may be configured to rotate about a central axis thereby moving the pallets along the pallet path. Each pallet comprises a shell defining a cavity associated with a predefined shape of a non-ruled surface of a target object and having shaped non-ruled inner surface and a perimeter. The shell may comprise a thermoplastic, metal or composite material. That the inner surface is associated with the target object non-ruled surface means that there is a degree of relationship between the shapes of each of the non-ruled surfaces that exceeds no relationship at all. The shape of the cavity's non-ruled surface may be matched to the non-ruled surface of a target object within manufacturing tolerances. In one embodiment, the shape of the cavity's non-ruled surface approximates the shape of the non-ruled surface of the target surface but need not precisely match the shape of the surface. In either embodiment, the inner surface of the cavity may comprise a lining of a low durometer silicone casting compound, a relatively soft compound, having a Shore ‘A’ hardness of about 15 may be used. Such a lining reduces the need for precise alignment between the cavity surface and the target object surface. The lining may define an array of perforations enabling a pressure applied to the pallet to act through the perforations of the lining upon the flexible membrane of the pallet. In one embodiment the array of perforations is shaped in association to the shape of the label to be applied.

A flexible membrane occludes the cavity along the perimeter. In one embodiment, the flexible membrane comprises a 0.5 mm natural latex membrane. In one embodiment, the flexible membrane may be perforated with a plurality of holes arranged according to the shape of the associated label. In this embodiment, a negative pressure applied to the cavity may be used to releasably attach the label to the membrane during the transfer and application process and to conform the label and membrane combination to at least a portion the shape of the inner cavity surface. In one embodiment, the overall dimensions of the pallet cavity are determined according to the overall dimensions of the target object and the presentation station dimensions as well. In one embodiment, the pallet will be moved such that the combination of the label, the membrane and the cavity surface is brought into contact with the target object's non-ruled surface. In this embodiment, the perimeter of the pallet cavity may necessarily move past at least a portion of the target object presentation mechanism. The dimensions of the pallet cavity are determined to facilitate this motion without any interference between the pallet and the presentations station elements. The inner cavity surface may thus be larger than the dimensions of the label itself.

The pallet turret may additionally comprise either a pallet cam track or individual pallet extension elements to enable the translation of each pallet to a position where the label—membrane—cavity combination is in contact with a presented target object. In one embodiment, the pallets are constrained to follow the pallet cam track which is configured to move each pallet in turn to a position wherein the label contacts the presented target object, the label transfer position.

In one embodiment, each pallet is moved to a label transfer position by the action of a pallet extension element. The pallet extension element may comprise a actuator which may include an alignment means to ensure that the pallet retains the proper orientation with regard to the target object as the pallet moves to the label transfer position. Alternatively, the pallet extension may comprise separate actuating and alignment elements. Exemplary actuators include linear motors, air and hydraulic cylinders, rack and pinion systems and other linear actuation systems as these are known in the art. Exemplary alignment systems include linear bearings, guide rails and similar devices.

The pressure source is connected to the cavity of each pallet of the array. In one embodiment, the pressure source comprises a vacuum or negative pressure source. The source may be connected to each pallet sequentially and in turn via a rotary union. In this embodiment, the rotation of the array of pallets about a central axis presents the pressure connection of each cavity to the negative pressure source over a prescribed portion of the unit rotation and results in the negative pressure being applied to the cavity over that portion of the rotation and not being applied over the remainder of the unit rotation. In this manner the magnitude of the applied pressure may be controlled as the pallet rotates about the central axis.

Each pallet may optionally be connected to a secondary pressure source. This source may be a positive pressure source and may also be connected to the array of pallets via a rotary union. The positive pressure source may be configured to apply positive pressure to the pallet cavity as the label is transferred to the target object. The application of a positive pressure at this time may assist in forcing residual air from the space between the label and the target object as well as assisting in conforming the label to the target non-ruled surface.

The negative pressure may cease to be applied to the cavity as the label is being transferred or the positive pressure magnitude may be selected to overcome the negative pressure and still accomplish the necessary label transfer.

The target-object presentation stations are adapted to hold individual target objects and constrained to circumnavigate a target-object path, a portion of the target-object path disposed adjacent to the pallet path. As is known in the package labeling arts, the presentation stations may be arrayed upon a rotary turret and may comprise a lower package holder or pad and an upper package holder sometimes referred to as a centering bell that follows a cam track and descends to capture a package that has been placed upon the lower pad.

Synchronizing the motion of the target-object presentation stations and the label pallets may be accomplished via a common drive system wherein the drive of the target-object turret and the drive of the pallet turret are coupled to each other using any of numerous known motion coupling means. In an alternative, the two turrets may each be driven by an independent drive unit and virtually synchronized using position encoders, or resolvers to continuously monitor the rotational position of each turret and to adjust these positions to maintain the desired relative positioning of the label pallets and the target-object stations. Servo or stepper motors may be utilized to drive each of the turrets and the synchronization may be accomplished using a single controller or by synchronizing multiple servo controllers.

In one embodiment, the target objects comprise substantially hollow containers having an opening such as unfilled containers for consumer products. In this embodiment, the presentation stations may additionally comprise a pressure source enabling the application of appositive pressure to the interior of the container for the purpose of pressurizing the container and thereby increasing the rigidity of the non-ruled surface at least during the label transfer. In this embodiment, the upper package holder or centering bell descends upon the target object as it is captured by the presentation station. The centering bell comprises a soft nozzle configured to seal against the opening of the container. The nozzle is operatively connected to the pressure source and enables the container to be pressurized as desired.

Each target object comprises a non-ruled surface having a pre-defined shape. The target objects are presented to the presentation stations such that the non-ruled surface will subsequently be presented to the label pallet as the presentation stations circumnavigate their path.

In one embodiment, the apparatus comprises a label heating element, the label heating element may be part of the label supply element such that the label is heated prior to or as it is peeled from the carrier film via a heated peel tip. Alternatively or additionally, the heating element may be disposed adjacent to the pallet path such that the labels disposed upon pallets may be subjected to heating. The heating element may comprise infra-red radiation elements, a combination of resistive or flame heating and forced air or other heating means as are known in the art. Heating the labels prior to the label transfer and while they are subject to the negative pressure applied to the pallet cavity may assist in conforming the labels to the shape of the inner cavity surface.

Heating the label may be accomplished via a dedicated label heating station and the motion of the label conformation pallets may be indexed such that each acquired label undergoes a dwell time at the label heating station. Alternatively, the labels may be heated by passing through a heating segment along the path of the label conformation elements such that the acquired labels are heated regardless of whether the motion of the pallets is indexed or continuous.

In one embodiment, labels comprising flexible films and pressure sensitive adhesive coatings are provided via label dispensing equipment. The provided labels are individually acquired by label pallets passing by the dispensing point of the label dispenser. The acquired labels are disposed upon the flexible membrane of the pallet with the adhesive coated side of the label away from the membrane. A negative pressure applied to the cavity each pallet results in the label transferring to the surface of the membrane of the pallet. The combination of the label and the membrane is deformed from its initial planar state to a shape largely in conformance with the shape of the inner surface of the cavity.

The label—pallet combination is moved to a position wherein the label is in contact with the non-ruled surface of the target object disposed upon a presentation station. The target object may be subjected to a positive pressure to inflate the object and increase the rigidity of the object's surfaces. The lining of the cavity enables the pallet to be moved past a point of interference between the label-membrane-lining combination as the combination is capable of deforming due to contact with the target object. Positive pressure may be applied to the pallet cavity and the pallet and target object are separated. Alternatively, without the application of positive pressure the natural elasticity of the membrane will cause it to return to the initial planar state. The positive pressure applied to the cavity conforms the label to the non-ruled surface of the object as the separation progresses and until the pressurized membrane can no longer contact the label. In one embodiment, the label is heated prior to being transferred to the object.

As illustrated in the FIGURE, labels 10 are provided by label supply element 400. Each label is provided as sensor 420 detects a label conformation pallet 110. The label conformation pallets 110 are arranged on label pallet turret 100. The turret 100 rotates passing each conformation pallet 110 sequentially past the label supply element 400 peel tip, the label heating element 500 and the target object presentation stations where the label 10 is transferred from the label conformation pallet 110 to the target object 20 located upon a presentation station of the target object turret 200. Pressure source 130, interacts with the label pallets 110 to provide a negative pressure as labels 10 are received from the label supply element 400 and a positive pressure as labels 10 are transferred to the objects 20. Actuator and guides 120 enable the label conformation pallet to translate from a first position upon the label pallet turret to a second position wherein the path of the label conformation pallet interferes with the path of the target object 20 to facilitate a transfer of the label 10 to the object 20.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An apparatus for applying a label to a non-ruled target surface, the apparatus comprising:
a. a label supply element, the label supply element comprising a peel tip disposed adjacent to a carrier film path and a label path diverging from the carrier film path at the peel tip;
b. an array of label conformation pallets constrained to circumnavigate a pallet path, at least a portion of the pallet path disposed adjacent to the label path, each pallet comprising a shell defining a cavity associated with a predefined shape of a non-ruled surface of a target object and having a perimeter and a perforated flexible membrane occluding the cavity along the perimeter;
c. a pressure source connected to the cavity of each pallet;
d. an array of target-object presentation stations adapted to hold individual target objects and constrained to circumnavigate a target-object path, a portion of the target-object path disposed adjacent to the pallet path;
wherein each target object comprises a non-ruled surface having a pre-defined shape.

2. The apparatus according to claim 1 further comprising a label heating element disposed adjacent to the pallet path.

3. The apparatus according to claim 1 wherein the array of pallets are disposed upon a pallet turret.

4. The apparatus according to claim 3, the pallet turret further comprising pallet extension elements.

5. The apparatus according to claim 3, the pallet turret further comprising a pallet cam track.

6. The apparatus according to claim 1 wherein each pallet is operably connected to a second pressure source.

7. The apparatus according to claim 1 wherein the array of target-object presentation stations are disposed upon a target-object turret.

8. The apparatus according to claim 7 wherein the target-object turret comprises a presentation-station cam track.

9. A method of applying a label to a non-ruled surface, the method comprising steps of:
a. providing a label comprising a first side and a second side, the second side at least partially coated with an adhesive, the label disposed upon a label path;
b. providing a label pallet comprising a cavity defining a perimeter and having a shaped inner wall comprising a non-ruled surface, and a membrane disposed adjacent to the cavity perimeter, the pallet circumnavigating a pallet path, a portion of the pallet path disposed adjacent to a portion of the label path;
c. transferring the label from a carrier film to the label pallet membrane;
d. applying a negative pressure to the cavity of the label pallet;
e. conforming a portion of the pallet membrane and label to a portion of the non-ruled surface of the cavity wall;
f. providing a target object comprising a non-ruled surface associated with the non-ruled surface of the shaped inner cavity wall;
g. translating the pallet membrane label combination to a location proximate to the non-ruled surface of the target object;
h. transferring the label from the pallet membrane to the non-ruled surface of the target object.

10. The method according to claim 9 comprising the step of heating the label prior to the step of transferring the label from the pallet membrane to the non-ruled surface of the target object.

11. The method according to claim 9 comprising the step of applying a positive pressure to the cavity as the label is transferred to the target object.
